(19) United States
(12) Patent Application Publication
(10) Pub. No.: US 2006/0027096 A1
(43) Pub. Date: Feb. 9, 2006

(54) Piston system and a piston-cylinder device provided therewith

(75) Inventors: Wilfried Giering, Mendig (DE); Benedikt Ohlig, Vallendar (DE); Erwin Michels, Kail (DE); Herbert Steinheuer, Bad Neuenahr (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: Lucas Automotive GmbH

(21) Appl. No.: 11/247,469

(22) Filed: Oct. 11, 2005

Related U.S. Application Data
(63) Continuation of application No. PCT/EP04/03430, filed on Mar. 31, 2004.

(30) Foreign Application Priority Data
Apr. 11, 2003 (DE) 103 16 838.9

(51) Int. Cl. F16J 9/00

(52) U.S. Cl. 92/248

(57) ABSTRACT

The invention relates to a piston device for a vehicle brake system, in particular for a pedal simulation apparatus of a vehicle brake system, having a piston shank extending in the direction of a longitudinal axis and having a radially extending piston disk formed on said piston shank, wherein the piston disk has a radially outer region, in which an outwardly open radial groove is formed, and wherein sealing means are or may be accommodated in the radial groove. In the invention it is further provided that the sealing means comprise a flexible sealing ring, which is or may be accommodated with axial and radial clearance in the radial groove, that the outside diameter of the sealing ring exceeds the outside diameter of the piston disk and that the piston disk is provided with at least one vent hole opening into the radial groove.

### CROSS-REFERENCE TO RELATED APPLICATIONS

This application is a continuation of International Application No. PCT/EP2004/003430 filed Mar. 31, 2004, the disclosures of which are incorporated herein by reference, and which claimed priority to German Patent Application No. 103 16 838.9 filed Apr. 11, 2003, the disclosures of which are incorporated herein by reference.

### BACKGROUND OF THE INVENTION

The invention relates to a piston device, in particular for a pedal simulation apparatus of a vehicle brake system.

In more recently designed vehicle brake systems it is customary for the pedal actuating force exerted on the brake pedal to be electronically measured and for a brake system to be controlled on the basis of the measured pedal actuating force.

This principle is used, for example, in electrohydraulic or electromechanical brake systems. In order nevertheless to be able to convey to the driver of a motor vehicle a resistance response of the brake pedal that is familiar to him from conventional vehicle brake systems, pedal simulation apparatuses are used, which simulate a pedal resistance, e.g. with a progressive characteristic curve. Such pedal simulation apparatuses are realized, as a rule, by spring elements for generating the resistance force. Such pedal simulation apparatuses moreover often provide pneumatic dampers that are able to influence the resistance response and resetting behaviour of the brake pedal. To realize such damping apparatuses, a piston disk of a piston device of the initially described type is guided sealingly inside a corresponding cylinder. On both sides of the piston disk working chambers are formed, wherein the fluid contained therein is displaced during an actuation of the brake pedal. This displacement may be damped, for example, by means of a throttle or the like, with the result that the resistance response of the brake pedal is directly influenced. It has however emerged that for realizing such damping apparatuses various components are required, such as for example throttle devices or non-return valves, which in an occasionally laborious manner are to be provided in such a way that they connect the two working chambers disposed on either side of the piston disk fluidically to one another. This leads to pedal simulation apparatuses of a relatively complicated design and hence to an undesirable increase of the manufacturing costs. What is more, as the number of components used increases, so too do the susceptibility to wear and the maintenance outlay of the brake system.

From DE 295 18 171 U1 a piston/cylinder arrangement for an opening mechanism of a glove compartment of a motor vehicle is known, the piston device of which comprises a piston shank and a radially extending piston disk formed on the piston shank, wherein the piston disk has an outwardly open radial groove, in which an O-ring is accommodated. The O-ring may move in axial direction within the radial groove, while being in fixed abutment in radial direction in the radial groove. The radial groove is penetrated by axial slots, the cross-sectional area of which varies in axial direction. Depending on the axial position of the O-ring within the radial groove, the O-ring encloses a specific throttle opening at the axial slot, so that in dependence upon the axial position of the O-ring different throttle effects may be achieved by the arrangement. There is however a throttle effect in every axial position of the O-ring.

### BRIEF SUMMARY OF THE INVENTION

An object of the present invention is to provide a piston device of the initially described type and a piston/cylinder arrangement designed with such a piston device that guarantees a reliable mode of operation while being of a simple and economical construction.

This object is achieved by a piston device, in particular for a pedal simulation apparatus of a vehicle brake system, having the features of claim 1.

If such a piston device according to the invention is inserted into a corresponding cylinder arrangement, then the flexible sealing ring rests against the inner wall of the cylinder. Because of its oversize relative to the piston disk and because of the axial and radial clearance within the radial groove, the sealing ring may distort in the radial groove and therefore provide a fluidic connection even between the axial chambers on either side of the piston disk via the at least one vent hole opening into the radial groove and via the radial groove. The distortion of the sealing ring within the radial groove therefore has the effect that in an idle state, in which there is no relative movement between the piston device and the cylinder, the distorted sealing ring does not abut over its entire circumference in a sealing manner both against the cylinder inner wall and against a flank of the radial groove. Rather, regions of non-abutment arise, which then in such an idle state allow fluid to pass through. The extent of the distortion depends upon the width of the radial groove and the dimensions of the sealing ring, in particular upon the axial clearance thereof, as well as upon the oversize of the sealing ring relative to the cylinder diameter. The sealing ring retains its distorted shape even in the event of a very slow movement of the piston device inside the cylinder.

If however the piston device is moved fast enough within the cylinder, then, because of the friction effects between the sealing ring and the cylinder inner wall, because of the inertia of the sealing ring and because of the growing pressure difference on both sides of the piston disk, this leads to the sealing ring being able to move, with slight deformation and utilizing the axial and radial clearance in the radial groove, into sealing abutment both against the cylinder inner wall and against an—in relation to the movement—trailing flank of the radial groove.

In this respect, it should be noted that the static friction of the sealing ring against the cylinder inner wall may be kept relatively low owing to the fact that, because of the axial clearance and the distortion of the sealing ring, the sealing ring has only a low radial tension. Thus, it presses also only with relatively low radial force upon the cylinder inner wall. This also explains the dimensional stability in the event of a slow movement of the piston device. The static friction and the inertia of the sealing ring are however sufficient to move the sealing ring into abutment over its full circumference against the cylinder inner wall and the trailing flank of the radial groove when the piston device is displaced fast enough. As soon as this state of abutment has been reached, a pressure difference between the two working chambers that results from a further movement has the effect that the sealing ring is pressed more strongly against the cylinder inner wall and the trailing flank of the radial groove. In said case, the sealing ring deforms, which intensifies the sealing effect.

In the state of abutment, in this basic form of the invention, fluidic connections between the two working chambers on either side of the piston disk via the at least one vent hole opening into the radial groove are prevented. The piston device according to the invention with simple constructional means makes it possible to realize a reliably operating valve. Given a suitable arrangement of the vent hole, it is also possible with the piston device according to the invention to realize a non-return valve, which, given a fast enough movement of the piston device, allows fluid to pass through in a predetermined direction only and prevents fluid from passing through in the other direction in accordance with the previous description.

In a development of the invention, it is provided that the radial groove is formed by a—viewed in an axis-containing section—U-shaped outer region of the piston disk. This measure allows the sealing ring to be held securely in the radial groove. It is further guaranteed that defined locating faces, i.e. flanks, of the radial groove are available for a sealing abutment.

As regards the at least one vent hole, in an embodiment of the invention it is provided that the vent hole extends in substantially radial direction through the transverse limb of the—viewed in an axis-containing section—U-shaped outer region. In other words, the at least one vent hole is a radial bore that connects one side of the piston device to the interior of the radial groove. The choice of the side, from which the vent hole starts, is crucial to the function as a non-return valve. Alternatively, a plurality of vent holes may be provided, which extend in radial or/and axial direction into the radial groove. Thus, for example, a flank may be pierced a plurality of times or be of a cage-like design.

A development of the invention provides at least one throttle device that allows a fluidic connection between both axial sides of the piston disk. Thus, in addition to the valve realized by means of the sealing ring, the behaviour of a pedal simulation apparatus designed with a piston device according to the invention may also be influenced additionally by the at least one throttle device. The throttle device may, for example, connect both sides of the piston device fluidically, but in a throttled manner, to one another.

The throttle device may comprise a throttle element provided in the piston disk. In order further to simplify the piston device according to the invention, the throttle device may be designed in the form of one or more throttle channels that extend in a groove-like manner through the radial groove. These throttle channels are designed in such a way that they allow a fluidic connection between the two working chambers even when the sealing ring abuts against the cylinder inner wall and the trailing flank. They are incorporated so deeply into the trailing flank that, even given high speeds of motion of the piston device and high pressure differences between both working chambers, they remain permanently open and a total closure is prevented by a deformation-related penetration of sealing ring material.

A development of the piston device according to the invention provides that a sensor element, in particular a magnetic sensor element, is provided on the piston for detecting the mutual current piston position. A brake pedal actuation may therefore be detected from the actual piston position and evaluated. A signal thus obtained may be used, for example, to control the further vehicle brake system that is mechanically uncoupled from the brake pedal.

For the sealing guidance of the piston device in or on further components of the vehicle brake system, it may be provided that at least one sealing element is disposed on the piston shank. The sealing element too may be designed in such a way that it may distort to a sufficiently large axial extent in a groove associated therewith. It may moreover be provided that the piston shank is designed with an axial passage. The axial passage may be used, for example, as the leadthrough of a force input element for a downstream brake system, e.g. a braking force generator or the like. This force input element may also be coupled mechanically to the piston device.

The invention, for achieving the previously stated object, further relates to a piston/cylinder arrangement for a vehicle brake system, in particular for a pedal simulation apparatus of a vehicle brake system that comprises a piston device of the previously described type and a cylinder. In this aspect of the invention, the cylinder accommodates the piston device in such a way that the piston disk separates a first working chamber from a second working chamber, wherein the flexible sealing ring comes into interaction with an inner wall of the cylinder in such a way that, in an idle position of piston device and cylinder, the sealing ring distorts relative to a radial plane orthogonal to the longitudinal axis and, upon a relative movement between the piston device and the cylinder in axial direction, moves into sealing abutment against the inner wall of the cylinder as well as against a flank of the radial groove, provided the latter has no throttle channel.

As already generally explained above with reference to the piston device, the oversize of the sealing ring relative to the inner wall of the cylinder and to the radial groove leads to a distortion of the sealing ring in the idle state, i.e. when the piston device and the cylinder are not moving relative to one another. However, as soon as the piston device is moved inside the cylinder, the frictional effects arising between the cylinder inner wall and the sealing ring, the inertia of the sealing ring and the growing pressure difference between both working chambers cause the sealing ring to deform inside the radial groove and move into abutment and sealing contact with a flank of the radial groove. The flank in this case is the—in relation to the respective relative movement of piston device and cylinder—trailing flank of the radial groove. If on completion of the relative movement the piston device remains once more in a specific position relative to the cylinder, then the sealing ring, optionally only after some time and after suppression of the pressure difference between both working chambers, e.g. by means of the throttle device, may distort inside the radial groove so that fluidic contact between the two working chambers may be restored by means of the at least one vent hole opening into the radial groove.

The sealing ring and the radial groove are dimensioned in such a way that the sealing ring upon a relative movement between the piston disk and the cylinder deforms in a radially inward direction, utilizing the clearance available in the radial groove. Such a deformation in a radially inward direction however occurs, not with radial or axial distortion, but merely in such a way that the sealing ring yields slightly in a radially inward direction, wherein it lies with its entire circumference harmoniously against the inner wall of the cylinder, apart from the optionally provided throttle channels.

In a development of the piston/cylinder arrangement according to the invention, it is provided that the first and the second working chamber are connected fluidically to one another by an additional fluid system. This fluid system may comprise a throttle element. The fluid system may be formed separately. In a preferred manner, it is however formed on the piston device, in particular in the region of the piston disk, e.g. by a throttle element, which is disposed in a through-bore extending in axial direction through the piston disk, or by the throttle channels.

Besides the sealing function and/or valve function, the radially outer region of the piston device having the sealing ring accommodated in the radial groove also performs a guide function during the movement of the piston device in the cylinder. In order further to improve the precision of the guidance of the piston device in the cylinder, a form of construction of the invention provides that the piston shank is guided in axial direction in a guide bush of the cylinder.

As already indicated above, the piston device may be used to detect a brake pedal actuation by means of the sensor element. A development of the piston/cylinder arrangement according to the invention accordingly provides that on the cylinder a complementary sensor element is provided, by means of which, for detecting the actual position of the piston device relative to the cylinder, the actual position of the sensor element is detectable.

The invention further relates to a pedal simulation apparatus for a vehicle brake system that is designed with a piston/cylinder arrangement of the previously described type and in particular with a piston device of the previously described type.

Other advantages of this invention will become apparent to those skilled in the art from the following detailed description of the preferred embodiment, when read in light of the accompanying drawings.

### BRIEF DESCRIPTION OF THE DRAWINGS

FIG. 1 a perspective view of a piston device according to the invention;

FIG. 2 a longitudinal sectional view of the piston device according to the invention in accordance with the cutting line II-II of FIG. 1 and

FIG. 3 a part-sectional view of a vehicle brake system according to the invention.

### DETAILED DESCRIPTION OF THE INVENTION

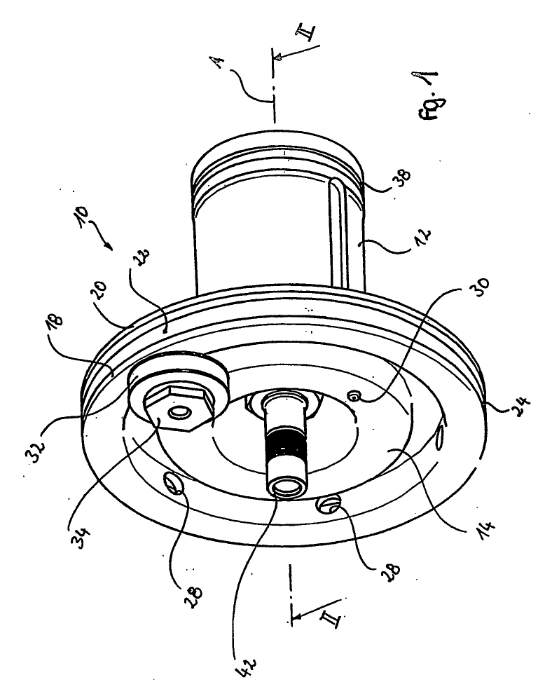

In FIGS. 1 to 3 a piston device according to the invention is generally denoted by 10. It comprises a piston shank 12 and a piston disk 14 formed on the piston shank 12 and extending substantially in radial direction therefrom.

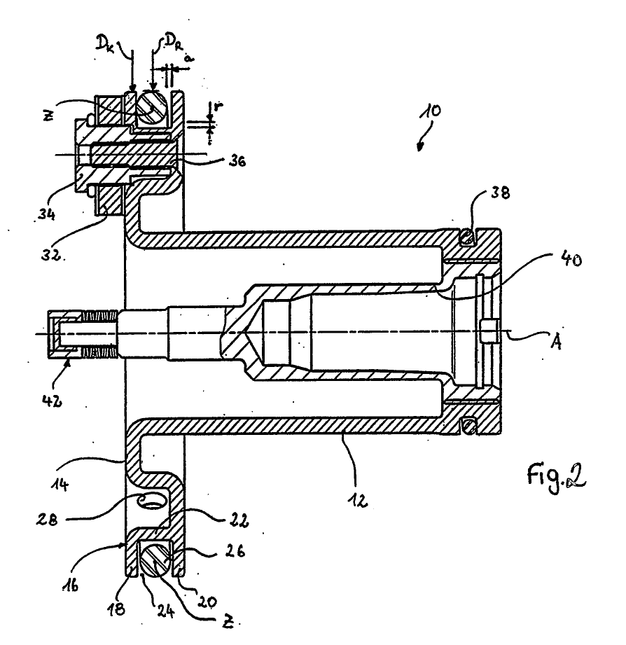

From an examination of FIG. 2, in particular, it is apparent that the piston disk 14, viewed in longitudinal section, has a multi-curved shape and in its radially outer region is designed with a U-shaped portion 16. The—in the section containing the longitudinal axis A—U-shaped portion comprises two radially extending radial limbs 18 and 20, which are connected to one another by a transverse limb 22 extending parallel to the longitudinal axis A. The radial limbs 18 and 20 as well as the transverse limb 22 form a radial groove 24, which extends in peripheral direction around the longitudinal axis A and in which a sealing ring 26 is accommodated. The sealing ring 26 is accommodated with an axial clearance a and a radial clearance r in the radial groove 24. It is formed from a rubber-elastic material and is capable of elastic deformation. Its outside diameter D_{R} is larger than the outside diameter D_{K} of the piston disk.

Extending through the material region described in the sectional view as transverse limb 22 is a plurality of radial bores 28, which are distributed in peripheral direction around the longitudinal axis A and fluidically connect the, in FIG. 2, left side of the piston disk 14 to the interior of the radial groove 24.

A throttle element 30 (see FIG. 1) is further provided, which is accommodated in an axial through-bore inside the piston disk 14 and provides a fluidic connection between the, in FIGS. 1 and 2, left and right side of the piston disk, albeit with a markedly reduced, fluidically effective diameter.

The drawings further show a magnetic sensor element 32, which is fastened to the piston disk 14 by means of two bolts 34 and 36, the threads of which engage one into the other. The sensor element 32 is used to detect the actual position of the piston device 10.

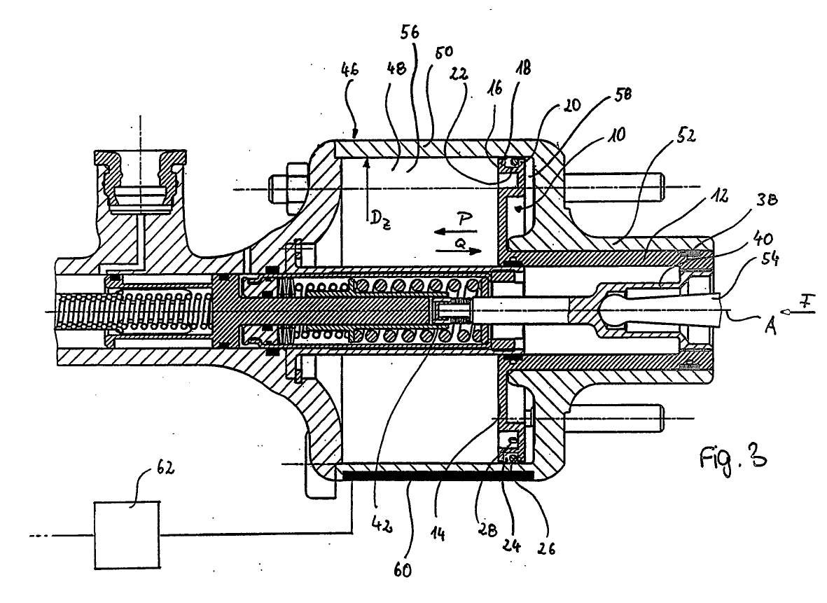

Finally, it is evident from FIG. 2 that on the piston shank 12 sealing means 38 are disposed in a region remote from the piston disk 14. As these annular sealing means too are accommodated with axial clearance in the circumferential groove associated therewith, because of the potential for axial distortion and the resulting reduction of radial tension they exhibit low-friction behaviour and yet deploy a sealing effect. A force transmission element 40 is moreover screwed into the piston device 10 at the, in FIG. 2, right end thereof. The force transmission element 40 is provided for transmitting a braking force introduced by a brake pedal (not shown) to a downstream brake system, which is indicated in FIG. 3. Such an introduction of braking force into the brake system may be effected in a damped manner by means of the arrangement at 42.

For the installation situation and for the operation of the piston device according to the invention in the context of a pedal simulation apparatus designed with a piston/cylinder arrangement, reference is made to the view according to FIG. 3. In this drawing, a diagrammatically illustrated piston device 10 according to the invention is guided displaceably in the direction of the longitudinal axis A in a housing 46. The housing 46 comprises a cylinder 50, which surrounds a cylindrical cavity 48, and a guide bush 52, which accommodates the shank 12 of the piston device 10.

The further components of the brake system, which is only partially shown in FIG. 3, will not be described in detail as they have no effect whatsoever on the mode of operation of the piston device 10 interacting with the cylinder 50.

The outside diameter D_{R} of the sealing ring 26 is oversized compared to the inside diameter D_{Z} of the cylinder 50. In the position shown in FIG. 3, in which piston device 10 initially does not move relative to the cylinder 50, this oversize of the sealing ring 26 leads to a distortion in axial direction, as is shown for example in FIG. 2. This means that the sealing ring 26 does not lie with a specific bench fibre, for example the central fibre Z, on a plane orthogonal to the longitudinal axis A, rather this central fibre Z changes its orientation relative to a plane orthogonal to the longitudinal axis A more than once. The sealing ring 26 therefore extends, with continuously harmonic abutment against the inner wall of the cylinder 50, in the idle position of piston device 10 and cylinder 50 in an undulating manner inside the radial groove 24. This undulating course is possible because—as already discussed above with reference to FIG. 2—the sealing ring 26 is accommodated with radial clearance r and axial clearance a inside the radial groove 24. By virtue of the possibility of distortion in axial direction, the sealing ring 26 in the fitted state has a relatively low radial tension and therefore in the idle state exerts only low radial forces on the inner wall of the cylinder 50. The static and sliding friction arising between the sealing ring 26 and the inner wall of the cylinder 50 is accordingly also relatively low.

In the event of a rapid pedal actuation, therefore, because a sufficiently high brake actuating force is exerted by a brake pedal via a force input element 54 on the force transmission element 40, the piston device 10 is displaced owing to the mechanical coupling of force transmission element 40 and piston shank 12 inside the housing 46. At the same time, the piston disk also moves in a corresponding manner in the direction of the longitudinal axis A. The sealing ring 26, which is closed over its circumference but lies with an undulating shape against the inner wall of the cylinder 50, at the start of this movement however remains—as far as possible—in its position because it is in static frictional engagement with the inner wall of the cylinder 50 and because of its inertia. Consequently, upon a movement according to arrow P of the piston disk 14 in axial direction, the sealing ring finally moves with its entire circumference into abutment against the, in FIG. 3, left flank of the radial limb 20 of the, in longitudinal section, U-shaped portion 16. This flank is described as the—during a movement of the piston device 10 in the direction of arrow P—trailing flank of the radial groove 24. The abutment of the sealing ring 26 both against the inner wall of the cylinder 50 and against the radial limb 20 is in each case a sealing abutment. Because of its oversize, the sealing ring 26 deforms slightly in a radially inward direction, but no longer has an undulating shape. By virtue of the sealing abutment of the sealing ring 26 against the inner wall of the cylinder 50 and the radial limb 20, the piston disk 14 is guided sealingly inside the cylinder 50. The two chambers 56 and 58 enclosed to the left and right of the piston disk 14 in the cylinder 50 are therefore sealingly separated from one another.

A further movement of the piston device 10 in axial direction according to arrow P leads to the development of a vacuum in the working chamber 58 and a pressure above atmospheric in the working chamber 56. This pressure above atmospheric also results in the sealing ring 26 being pressed more strongly into abutment with the inner wall of the cylinder 50 and the trailing flank of the radial groove 24, this further increasing its sealing effect. Because of the developing vacuum, the resistance that the driver senses via the force input element 54 at the brake pedal increases. In order to influence this resistance, fluid from the working chamber 56 is transferred via the throttle device 30 to the working chamber 58, albeit in a throttled manner.

As soon as the brake pedal is released, the piston device 10 with the piston disk 14 moves under the action of resetting springs (not shown in detail) according to arrow Q back into its initial position. During this process the previously described effect also arises, namely the displacement of the sealing ring 26 inside the radial groove 24 under the effect of static friction until the sealing ring 26 abuts against the flank of the radial groove formed on the limb 18. However, this effect does not result in the working chamber 56 being sealed off from the working chamber 58 because fluid from the chamber 58 may flow past the radially outer edge of the radial limb 20, through the radial groove 24 and through the axial bores 28 into the chamber 56 and may effect a pressure equalization. A resetting movement according to arrow Q may therefore occur much faster and with less damping than a movement of the piston device 10 according to arrow P. The sealing ring 26 in cooperation with the radial groove 24 and the limbs 18 and 20 performs the function of a non-return valve, which blocks sealingly in direction of motion P and allows a flow of fluid between the two working chambers 56 and 58 in direction of motion Q.

It should additionally be pointed out that on the outside of the cylinder 50 a sensor device 60 is disposed, which likewise extends in the direction of the longitudinal axis A and which is coupled to a control unit 62 for signal transmission. The sensor unit 60 detects the position of the sensor element 32, which is not shown in FIG. 3, and communicates this position to the control unit 62. A pedal actuation may therefore be reliably detected and assigned parameters. The signals obtained may then be utilized for further control of the vehicle brake system.

It should further be pointed out that the radial limb 18 as well as the transverse limb 22 need not be made of solid material and may instead be designed like a grid or with a plurality of holes. Only the radial limb 20 is required to provide a locating face for the sealing ring 26.

By means of the invention, pedal simulation apparatuses with a piston/cylinder arrangement may be considerably simplified.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. Piston device, in particular for a pedal simulation apparatus of a vehicle brake system, having a piston shank extending in the direction of a longitudinal axis and having a radially extending piston disk formed on said piston shank, wherein the piston disk has a radially outer region, in which an outwardly open radial groove is formed, and wherein sealing means are or may be accommodated in the radial groove, wherein the sealing means comprise a flexible sealing ring, which is or may be accommodated with axial and radial clearance in the radial groove, wherein the outside diameter of the sealing ring exceeds the outside diameter of the piston disk, so that the seal upon contact with a cylinder wall tuned to the piston device distorts relative to a plane orthogonal to the longitudinal axis, and that the piston disk is provided with at least one vent hole opening into the radial groove.

2. Piston device according to claim 1,
wherein the radial groove is formed by a—viewed in an axis-containing section—U-shaped outer region of the piston disk.

3. Piston device according to claim 2,
wherein the at least one vent hole extends in substantially radial direction through the transverse limb of the—viewed in an axis-containing section—U-shaped outer region.

4. Piston device according to claim 1,
wherein a plurality of vent holes are provided, which extend in radial or axial direction into the radial groove.

5. Piston device according to claim 1,
characterized by at least one throttle device, which allows a fluidic connection between both axial sides of the piston disk.

6. Piston device according to claim 5,
wherein the throttle device comprises a throttle element provided in the piston disk.

7. Piston device according to claim 5,
wherein the throttle device comprises a throttle channel provided in the radial groove.

8. Piston device according to claim 1,
characterized by a sensor element for detecting the actual piston position.

9. Piston device according to claim 1,
wherein at least one sealing element is disposed on the piston shank.

10. Piston device according to claim 9, wherein the sealing element is accommodated with axial clearance in the piston shank and that the outside diameter of the sealing element exceeds the outside diameter of the piston shank.

11. Piston device according to claim 1,
wherein the piston shank is designed with an axial passage.

12. Piston/cylinder arrangement, in particular for a pedal simulation apparatus of a vehicle brake system, comprising a piston device according to claim 1 and a cylinder, which accommodates the piston device in such a way that the piston disk separates a first working chamber from a second working chamber,
wherein the flexible sealing ring comes into interaction with an inner wall of the cylinder in such a way that, in an idle position of piston device and cylinder, it distorts relative to a radial plane orthogonal to the longitudinal axis and, upon a relative movement between the piston device and the cylinder in axial direction, it moves into sealing abutment against the inner wall of the cylinder as well as the radial groove.

13. Piston/cylinder arrangement according to claim 12,
wherein, upon a relative movement between the piston disk and the cylinder, the sealing ring deforms in a radially inward direction, utilizing the clearance available in the radial groove.

14. Piston/cylinder arrangement according to claim 12,
wherein the first and the second working chamber are fluidically connected to one another by an additional fluid system.

15. Piston/cylinder arrangement according to claim 14, wherein the fluid system comprises a throttle element.

16. Piston/cylinder arrangement according to claim 12,
wherein the piston shank is guided in axial direction in a guide bush of the cylinder.

17. Piston/cylinder arrangement according to claim 12,
wherein on the cylinder a complementary sensor element is provided, by means of which, for detecting the actual position of the piston device relative to the cylinder, the actual position of the sensor element is detectable.

18. Pedal simulation apparatus for a vehicle brake system, designed with a piston/cylinder arrangement according to claim 12.

19. Piston device according to claim 1,
wherein a plurality of vent holes are provided, which extend in radial and axial direction into the radial groove.

20. Piston device according to claim 8, wherein the sensor element for detecting the actual piston position is a magnetic sensor element
